(19) United States
(12) Patent Application Publication
(10) Pub. No.: US 2021/0314665 A1
(43) Pub. Date: Oct. 7, 2021

(54) MEDIA CAPTURE AND DISTRIBUTION

(71) Applicant: Rockstar Music, Inc., El Segundo, CA (US)

(72) Inventors: Benjamin Aaron Davenport, Brooklyn, NY (US); David Scott Moricca, El Segundo, CA (US); Michael Edward Orth, Brentwood, TN (US)

(21) Appl. No.: 17/301,544

(22) Filed: Apr. 6, 2021

Related U.S. Application Data
(60) Provisional application No. 63/006,378, filed on Apr. 7, 2020.

(51) Int. Cl. H04N 21/462; G06F 3/16; H04N 21/431; H04N 21/482; H04N 21/485

(52) U.S. Cl. CPC H04N 21/4622; G06F 3/165; H04N 21/4858; H04N 21/482; H04N 21/4316

(57) ABSTRACT

An example system for distributing media content can include: a processor; memory encoding instructions which, when executed by the processor, cause the system to create a graphical user interface including: a sources pane listing a plurality of sources of media content, the media content including both pre-recorded media content and live stream content; a timeline listing a plurality of cards in a linear order, each of the plurality of cards representing specific media content; a preview window displaying selected media content from the timeline; a broadcast window displaying media content that is currently being broadcast; and a channels pane displaying a plurality of channels to which the media content is broadcast.

### BACKGROUND

Capturing and distributing media content such as video can be important, particularly to social media influencers and businesses trying to connect with customers. Content generators can lack the technical knowledge to even capture content given the disparate tools to capture media such as video and audio. Further, editing and distribution of that content can be complicated given the number of social media platforms available.

### SUMMARY

In one aspect, an example system for distributing media content can include: a processor; memory encoding instructions which, when executed by the processor, cause the system to create a graphical user interface including: a sources pane listing a plurality of sources of media content, the media content including both pre-recorded media content and live stream content; a timeline listing a plurality of cards in a linear order, each of the plurality of cards representing specific media content; a preview window displaying selected media content from the timeline; a broadcast window displaying media content that is currently being broadcast; and a channels pane displaying a plurality of channels to which the media content is broadcast

### FIGURES

FIG. 1 shows an example media capture and distribution system.

FIG. 2 shows an example media content server of the system of FIG. 1.

FIG. 3 shows an example method for creating and distributing media content as a broadcast using the system of FIG. 1.

FIG. 4 shows another example method for creating and distributing media content as a broadcast using the system of FIG. 1.

FIG. 5 shows an example method for rendering and encoding the media content using the media content server of FIG. 2.

FIG. 6 shows an example user interface for capture of media content using the media content server of FIG. 2.

FIG. 7 shows an example interface for creating the live streams using the media content server of FIG. 2.

FIG. 8 shows the interface of FIG. 7 including example live sources of media content.

FIG. 9 shows the interface of FIG. 7 including an example pop-up window identifying a guest broadcaster.

FIG. 10 shows the interface of FIG. 7 including an example pop-up window allowing for upload of media content.

FIG. 11 shows the interface of FIG. 7 including an example timeline indicating an order of media content.

FIG. 12 shows the interface of FIG. 7 including an example pop-up window providing controls for distribution of the broadcast on the various channels.

FIG. 13 shows the interface of FIG. 7 including an example control pane including graphics that can be added to a broadcast.

FIG. 14 shows the control pane of FIG. 13 including example controls for polls that can be added to the broadcast.

FIG. 15 shows the control pane of FIG. 13 including example templates that define layouts for the broadcast.

FIG. 16 shows various example components of the media content server of FIG. 2.

FIG. 17 shows an example scenes module of the media content server of FIG. 2.

FIG. 18 shows an example remote production module of the media content server of FIG. 2.

FIG. 19 shows the interface of FIG. 7 including additional example live sources of media content.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates to the capture and distribution of media content, such as video. In example embodiments, a computing device is used to capture video. That video is uploaded to a server, where the video can be edited and distributed.

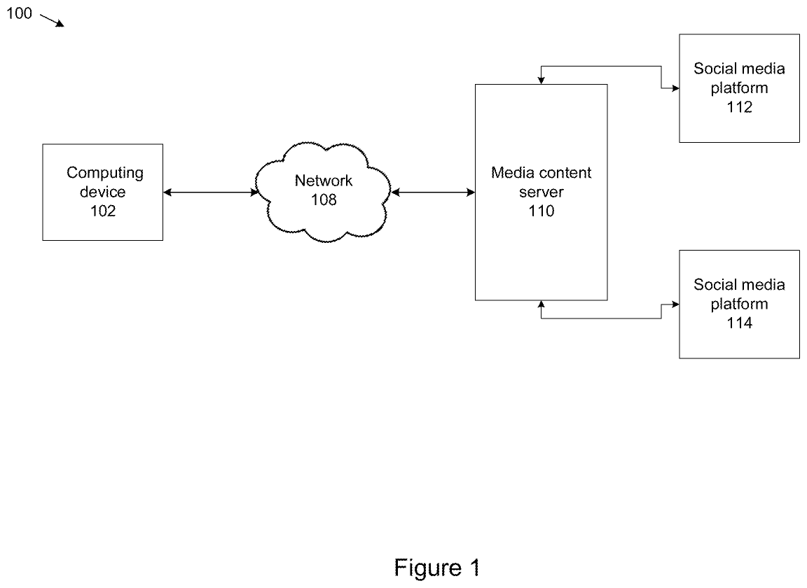

FIG. 1 is a block diagram depicting an example media capture and distribution system 100. As illustrated, the system 100 includes a computing device 102 that communicates with a media content server 110 over a network 106, such as a local area network, wide area network, a wireless or cellular communication network, or the like. The media content server 110, in turn, provides content to social media platforms 112, 114.

In this example, the computing device 102 is capable of capturing media, such as audio and video. The computing device 102 can be a mobile device like a smart phone, tablet, laptop, or the like. The computing device 102 can also be a desktop or similar computer. In this example, the computing device 102 includes a client application that accesses a camera and microphone to capture media content including audio and video. Although a single computing device 102 is shown, many hundreds or thousands of computing devices can capture and send media content to the media content server 110.

The computing device 102, in turn, uploads the media content to the media content server 110. The media content server 110 is programmed to assemble the media content and allow the media content to be edited (e.g., manipulate start/stop time) and combined with other media (e.g., combine multiple streams of media content). The media content server 110 is further programmed to distribute the media content to the social media platforms 112, 114. Although a single media content server 110 is shown, multiple computing devices can be used to implement the media content server 110, such as through cloud computing.

The social media platforms 112, 114 allow for the distribution of content to many hundreds or thousands of members of the platforms. Although two social medial platforms are shown, many more can be provided. Examples of social media platforms include, without limitation, Facebook, LinkedIn, Twitter, YouTube, and Twitch.

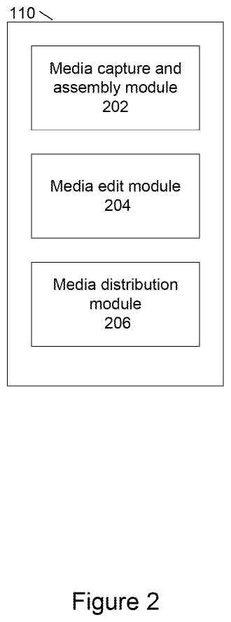

Referring now to FIG. 2, additional details are shown about the logical components of the media content server 110. The example media content server 110 includes a media capture and assembly module 202, a media edit module 204, and a media distribution module 206.

The media capture and assembly module 202 is programmed to receive content from the computing device 102 and assembly that content. For example, as described further, the computing device 102 can be programmed to send media content to the media content server 110 in chunks, particularly when the network 108 is unreliable or unavailable. The media capture and assembly module 202 assembles the chunks in the correct order for editing, replay, and distribution.

The media edit module 204 allows the user to edit the assembled media content. In further exampled provided below, the editing can be to the media content itself or involve combining the media content with other media content.

The media distribution module 206 allows the edited media content to be easily distributed. For instance, the media distribution module 206 is programmed to interface with each of the channels 112, 114 (e.g., social media platforms). The media distribution module 206 automates the distribution of the edited media content. As described further below, the media distribution module 206 can provide a single set of controls that allow the edited media content to be distributed to a subset or all of the channels 112, 114.

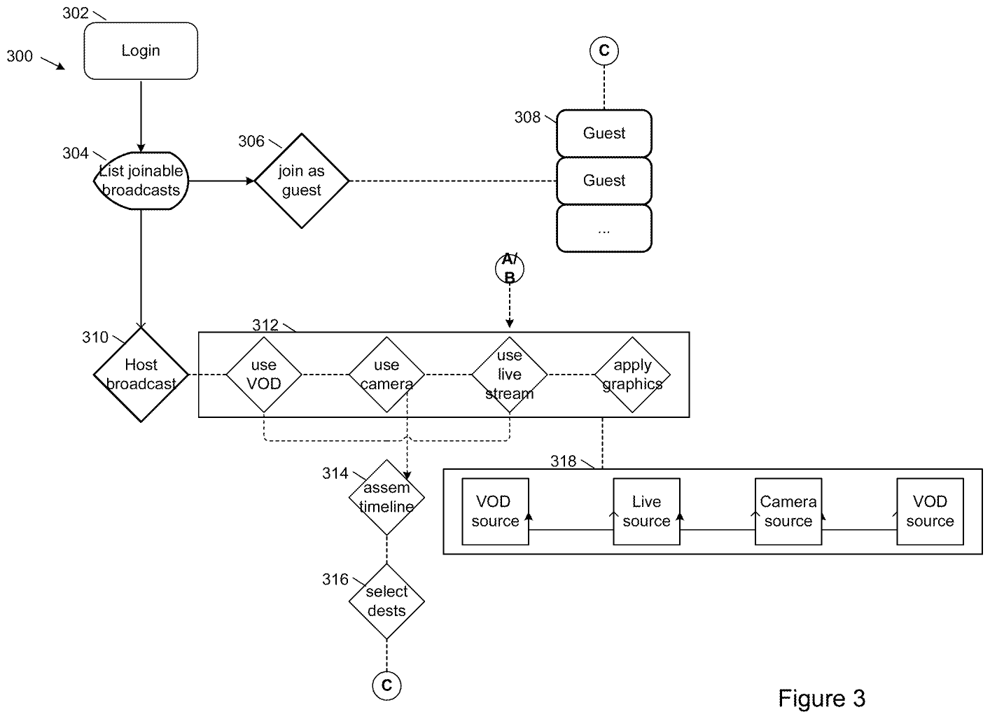

Referring now to FIG. 3, an example method 300 for creating and distributing media content as a broadcast is provided. The example method 300 provides end-to-end broadcasting and recording (within a browser) and backed by a cloud-based composite engine. This results in keeping the heavy workload encoding off of the computing device 102.

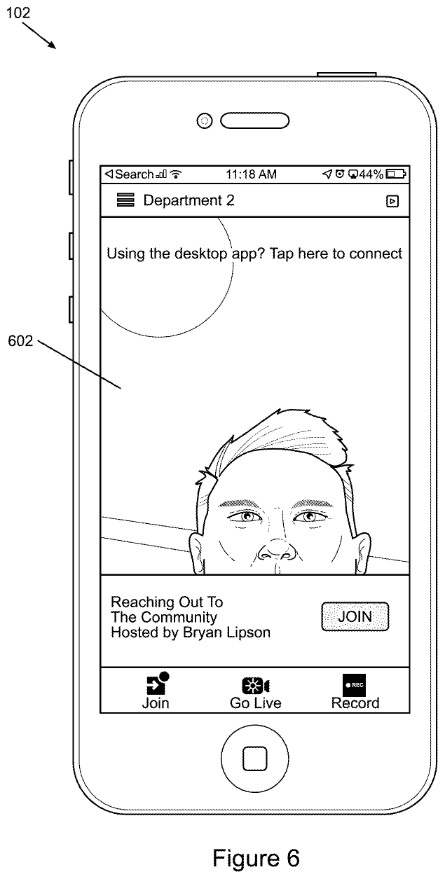

Example usage involves: create, produce, and curate high quality content for both live and on-demand formats using a variety of pre-made video-on-demands, connected cameras and video/audio devices, and other live streams. Much of this method 300 is depicted in the graphical user interfaces shown in FIGS. 6-15.

At operation 302, a login request is received at the media content server 110. For instance, a user name and password (as well as other authentication information, such as a second factor) can be received through a browser request. Next, at operation 304, a list of broadcasts is provided. A selection is received from the user indicating if the user wishes to join a broadcast as a guest or host. If a guest selection is received, control is passed to operation 308, and the media content server 110 presents the user with the selected media content.

Alternatively, if the selection is to host a broadcast, control is passed to operation 310. At this point, a selection is received on the type of broadcast. Various types of broadcast include video-on-demand, raw camera and live streaming, etc. The broadcast can be enhanced through the application of graphics.

Further, a selection of the sources of the media content is received at operation 318. This can involve using various different sources on the computing device 102. These sources can include, without limitation, the camera and microphone. Further, video-on-demand and live sources from other feeds can be added.

Next, at operation 314, the media content server 110 assembles the broadcast into a timeline that defines when and how the media content is delivered. Finally, at operation 316, a selection of the destination streaming protocol types can be received, such as real-time messaging protocol (RTMP) and/or real-time transport protocol (RTP) endpoints. Other protocols can be used.

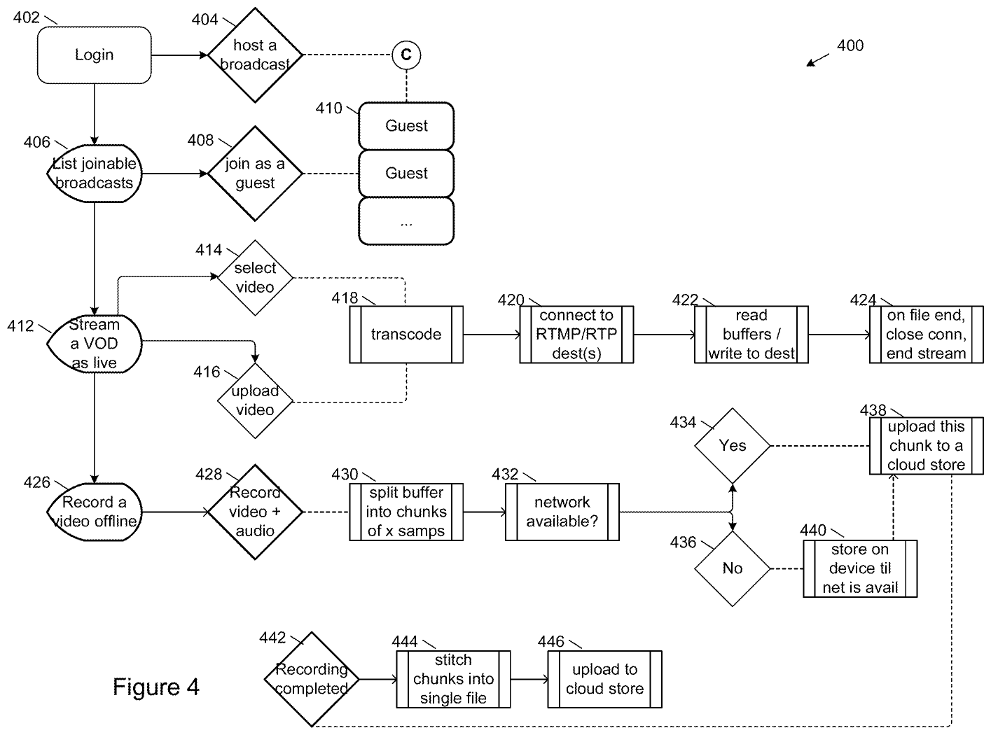

Referring now to FIG. 4, an example method 400 for creating and distributing media content as a broadcast is provided. The method 400 is similar to the method 300 provided above, except the source of the broadcast is a video-on-demand source that is broadcast as a live stream.

Generally, the example method 400 allows pre-recorded content to be broadcast as a live stream that removes both the jitters of live broadcasting and risks that come with no take-back content. With the method 400, a pre-recorded video is received, along with selection of any linked endpoint destinations (optional). The origin restreams the content in real-time.

Example usage involves: live content where limited bandwidth/hardware is available; or broad engagement without the worry of botching a live broadcast. Offline recording allows a user to record video and audio to the media content server 110 even when no network is available while recording.

The video and audio buffers on the computing device 102 as the data flows into the device and break it into small chunks. Once a chunk is ready to be processed, the chunk is uploaded to the media content server 110 immediately if the network 108 is available or stored on the computing device 102 for later upload when the network 108 becomes available. One example of code to accomplish the breaking of the data (video/audio) into chunks is the following.
List<String>chunks=repo.getChunks(id);
List<String>paths=chunks.sortBy(timestamp, ascending);
encoder.input(paths).output(“path.mp4”);

When the recording is ended and all of the chunks are uploaded to the media content server 110, all the chunks are stitched together into a single file as if network availability/reliability was never an issue. This allows for the production of video-on-demand content where limited bandwidth/network availability constraints are a factor. One could record a video from deep inside a cave or at the bottom of the ocean and end up with a finished product.

Referring now to the example method 400, at operation 402, a login request is received at the media content server 110. For instance, a user name and password (as well as other authentication information, such as a second factor) can be received through a browser request.

Once authenticated, a selection is received from the user to join a broadcast (operation 404) or host a broadcast (operation 404-see method 300). Specifically, at operation 404, a list of broadcasts is provided. A selection is received from the user indicating if the user wishes to join a broadcast as a guest or host. If a guest selection is received, control is passed to operation 410, and the media content server 110 presents the user with the selected media content.

Alternatively, if the selection is not to join or host a broadcast, control is instead passed to operation 412, where the selection to stream a pre-recorded (e.g., video-on-demand) media content as a live stream is received from the user. At this juncture, a selection is received from the user to either upload media content (operation 416) or select media content (operation 414) that has already been stored on the media content server 110.

Next, at operation 418, the selected media content is transcoded, and a connection to an RTMP/RTP endpoint is made at operation 420. Next, at operation 422, the media content server 110 reads buffers and writes to the destination endpoint as if the video is a live stream, so that viewers view the media content as if the media content is being live streamed. For instance, the media content can be streamed as a Facebook Live real-time stream. Finally, at operation 424, the media content server 110 reaches the end of the media content and closes the stream.

In addition to live streaming pre-recorded content, a selection can be received from the user to instead record off-line media content at operation 426. Once selected, the computing device 102 is used to capture audio and video, and the captured media content is split into chunks, as noted above.

Once a chunk is ready to be processed, the chunk is uploaded to the media content server immediately at operations 432, 434, 438 if the network is available or stored on the computing device at operation 436, 440 for later upload when the network becomes available at operation 438.

When the recording is complete and all of the chunks are uploaded to the media content server 110 at operation 442, all the chunks are stitched together into a single file at operation 444 and stored at operation 446 as if network availability/reliability was never an issue. This allows for the production of video-on-demand content where limited bandwidth/network availability constraints are a factor. For instance, the stored media content can later be streamed as a live stream per operations 412-424.

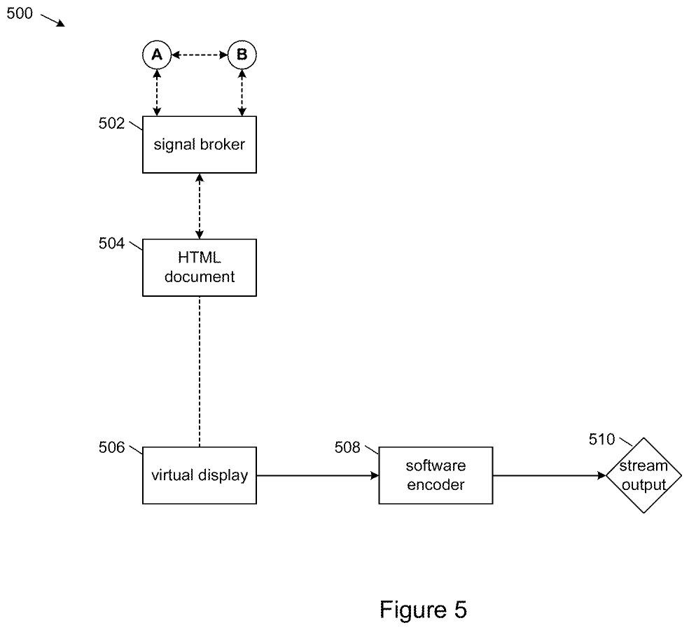

Referring now to FIG. 5, an example method for 500 for rendering and encoding the media content at the media content server 110 (as opposed to the computing device 102) is shown. As previously noted, this configuration saves on the resource-heavy encoding process at the client devices.

Specifically, video encoding on the client can be extremely expensive with respect to both CPU and GPU. In an effort to support as many client machines as possible, the media content is constructed and encoded in the cloud (i.e., on the media content server 110) so that intensive tasks for the client devices are minimized. This is done by marshaling path and pointer data up to the engine via data signaling where the host broadcast's scenes, layouts, and timeline are composited and encoded. Using capture from HTML, the composite can encode and stream anything supported by a web browser.

At operation 502 of the method 500, the media content is received, either from the client or as stored on the media content server. Next, at operation 504, the HTML document is loaded that is to be used for drawing the composite, which can be any browser instance or html engine (e.g., Chrome, Firefox, etc.) that loads a web page or HTML content.

Next, at operation 506, on the media content server(s), in lieu of a physical display (monitor) a software application (or virtual display) can load and display the browser content from operation 504. The software display can be any emulator software (e.g., X-Server/X11, etc.). Next, at operation 508, a software encoder (e.g., FFMpeg, GStreamer, VLC, etc.) accepts the input from the virtual display (at operation 506) as an input source to be manipulated, encoded, and sent to an ingest point as needed (e.g., RTSP/RTMP, etc.). Finally, at operation 510, the media content is streamed.

For example, assume a pipeline with FFMpeg, capturing a browser-loaded X11 screen source and streaming RTMP to an ingest point: ffmpeg-video_size 1920×1080-framerate 30-fx11grab-i:0.0+100,200-f pulse-ac 2-i default-f flv rtmp://127.0.0.1/ingest/default/output. Other examples are possible.

Referring now to FIGS. 6-15, example graphical user interfaces for implementing the system 100 are provided. Generally, these interfaces are served by the computing device 102 and media content server 110 and can be accessed using any computing device, such as the computing device 102.

FIG. 6 illustrates an example of the computing device 102, which is a mobile computing device. The computing device 102 includes an application with an interface 602. The interface 602 allows for the capture of media content. The interface 602 includes controls that allow the computing device 102 to receive various selections from the user, such as joining a broadcast from the media content server 110. The interface 602 also includes controls that allow for the recording and live streaming of media content captured by the computing device 102. For instance, the camera and microphone of the computing device 102 can capture media content that is then chunked and delivered to the media content server 110.

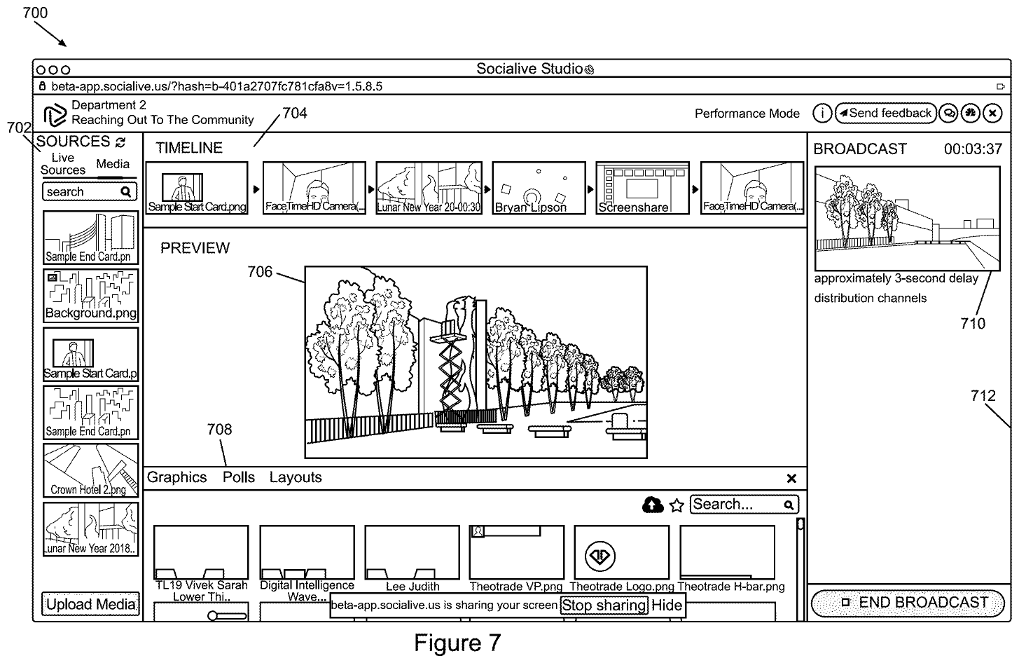

Referring now to FIG. 7, an example interface 700 for creating the live streams on the media content server 110 is provided.

In this example, the interface 700 includes a sources panel 702 that allows for the media content server 110 to receive the selection of one or more sources of media content from the user. For instance, the sources can include pre-recorded media content (“Media”) and/or live streaming media content (“Live Sources”). In this example, the interface 700 allows the user to simply drag media content from the sources panel 702 to a timeline 704.

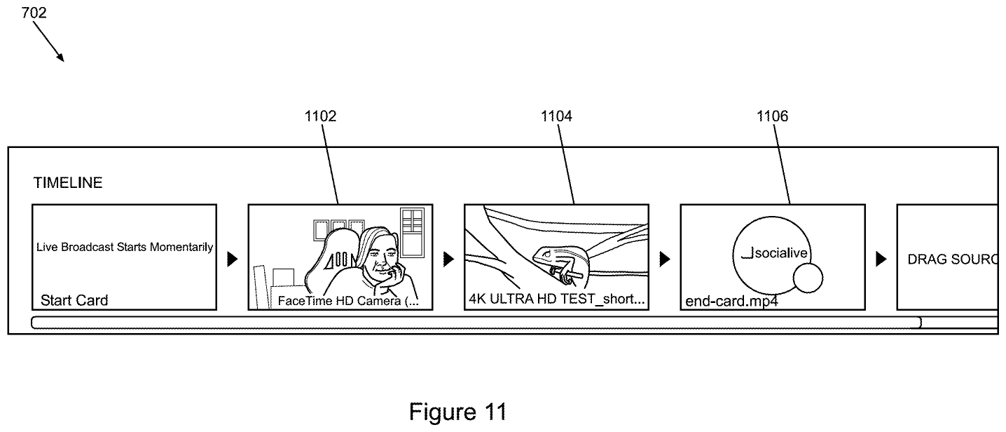

The timeline 704 defines the linear order in which media content will be broadcast. The interface 700 allows the user to move the order of the media content around by dragging individual items before and after other items shown on the timeline 704. See FIG. 11.

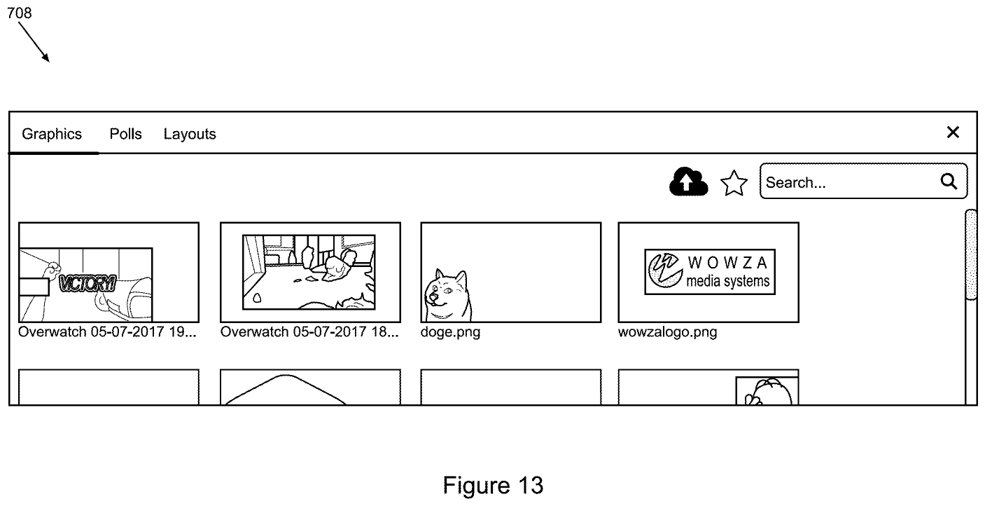

The interface 700 also provides a preview window 706 that shows a preview of the media content that is currently selected in the timeline 704. Further, the interface 700 includes a control pane 708 that allows for various attributes such as graphics, polls, and layouts to be added to the broadcast, as described further below in reference to FIGS. 13-15.

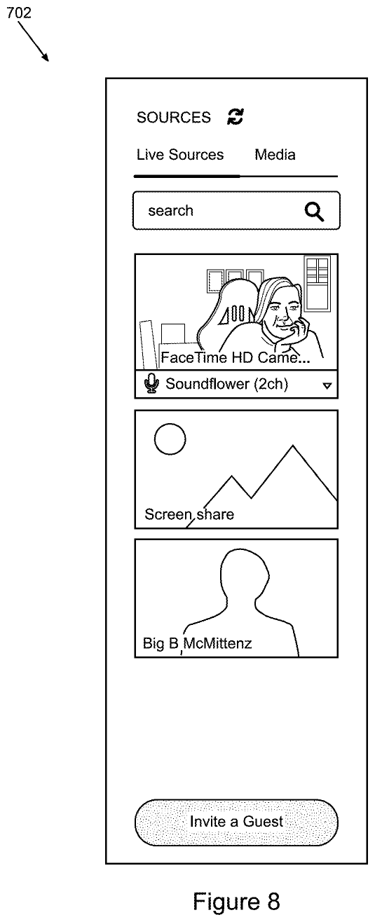

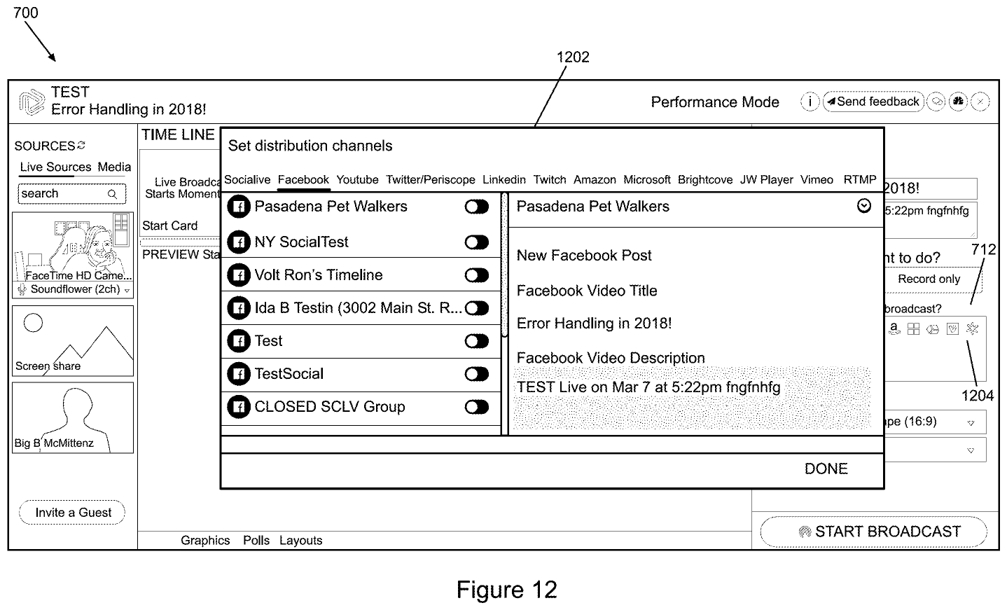

The interface 700 further provides a broadcast window 710 that shows the media content that is actually being broadcast at that time. The media content can be on a delay (e.g., 3 seconds) to allow for editing. Finally, the interface 700 includes a distribution channels pane 712 with the various social media platforms listed for distribution, as described further below in reference to FIGS. 8 and 12. Further, the distribution channels pane 712 lists several social media platforms on which the media is being broadcast. Each entry on the distribution channels pane 712 includes the social platform name and status (e.g., green light circle indicating broadcasting as normal, red light circle indicating no broadcasting or a problem associated therewith). Further, each entry can include a link which, when a select is received, causes a browser or other associated application to load the selected social media platform. Social media platforms can be added and removed. See FIG. 12.

Referring now to FIG. 8, another view of the example interface 700 is shown. In this instance, the sources panel 702 shows live sources of media content, which are themselves live streams.

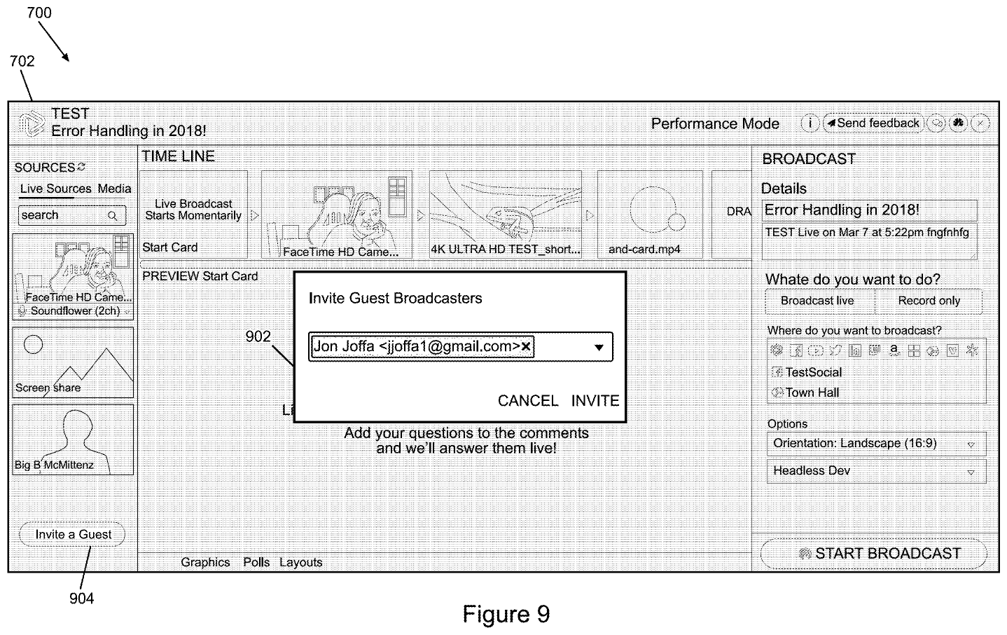

Referring now to FIG. 9, an example pop-up window 902 of the interface 700 is shown. This window 902 is generated upon receiving a selection of control 904. Once a guest broadcaster is identified in the window 902 (e.g., by email address or other identifier, such as user name, etc.), the media content server 110 contacts the invited guest broadcaster and adds a live stream from that guest broadcaster to the “Live Sources” tab of the sources panel 702 when the guest broadcaster a successfully connection is received by the media content server 110.

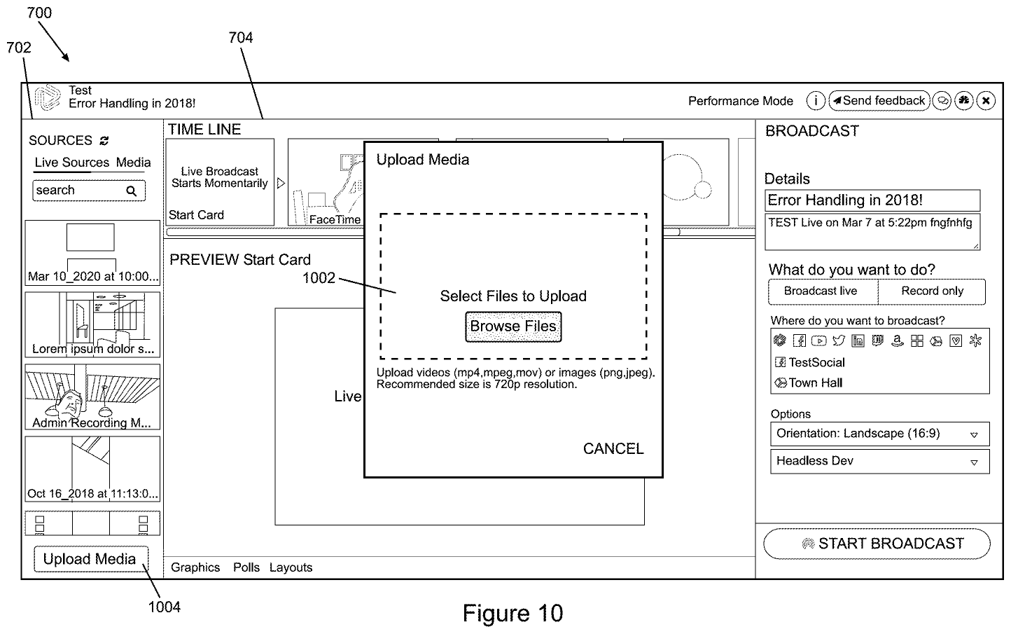

Referring now to FIG. 10, another example pop-up window 1002 of the interface 700 is shown. In this example, the window 1002 is generated when a selection of an upload control 1004 is received in the sources panel 702. Upon selection, the window 1002 allows the media content server 110 to receive recorded media content (e.g., audio, pictures, video) that are then listed in the sources panel 702 (under the “Media” tab). The interface 700 then allows the uploaded media, as noted, to be dragged into the timeline 704 for inclusion in the broadcast.

FIG. 11 shows that the timeline 704 is made up of cards 1102, 1104, 1106 that represent the order in which media content will be displayed during a broadcast. Each of the cards 1102, 1104, 1106 represents media content that will be played sequentially during the broadcast. The interface allows the cards to be added, removed, and reordered through dragging and dropping into and out of the timeline 704.

Referring now to FIG. 12, a pop-up window 1202 is generated when selection of a control 1204 on the distribution channels pane 712 is received. The windows 1202 provides controls for distribution of the broadcast on the various channels, including social media platforms. Each channel is listed, such as Facebook. Within the Facebook channel, parameters associated with the broadcast can be defined, like title and description. Further, various groups within Facebook are listed and selectable to allow for distribution of the broadcast. If selected, the broadcast is distributed to that Facebook group, such as through a post on the wall of the group. If deselected, the broadcast is not distributed to that Facebook group. Each channel is selectable and definable in this manner.

Referring now to FIGS. 13-15, additional details about the control pane 708 are provided.

In a “Graphics” tab shown in FIG. 13, the control pane 708 displays various graphics that can be added to the broadcast. The graphics can include audio, pictures, and/or video that is uploaded/stored on the media content server 110. In some examples, the graphics on the control pane 708 are draggable onto the timeline 704 for display at a certain point in the broadcast. Further, the graphics are draggable onto a portion of the preview window 706 so that the graphic is positioned on the media content that is currently depicted in the preview window 706. The graphic can be resized, repositioned, and added/removed as desired.

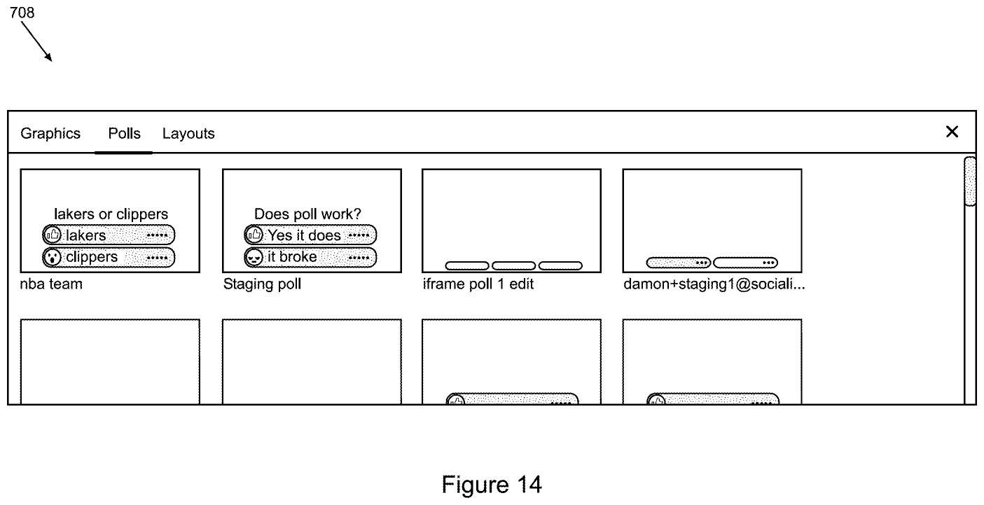

In a “Polls” tab shown in FIG. 14, the control pane 708 displays various controls that can be added to the broadcast. These controls can include polls that solicit feedback from the viewer. For instance, one poll labeled “nba team” can solicit feedback on the viewer's favorite NBA team during a broadcast about NBA highlights. The poll is draggable onto the timeline 704 and/or the preview window 706 so that the poll is displayed at the desired time and location. The viewer can interact with the poll to provide the desired feedback, such as select a favorite team from among a list of NBA teams in the poll.

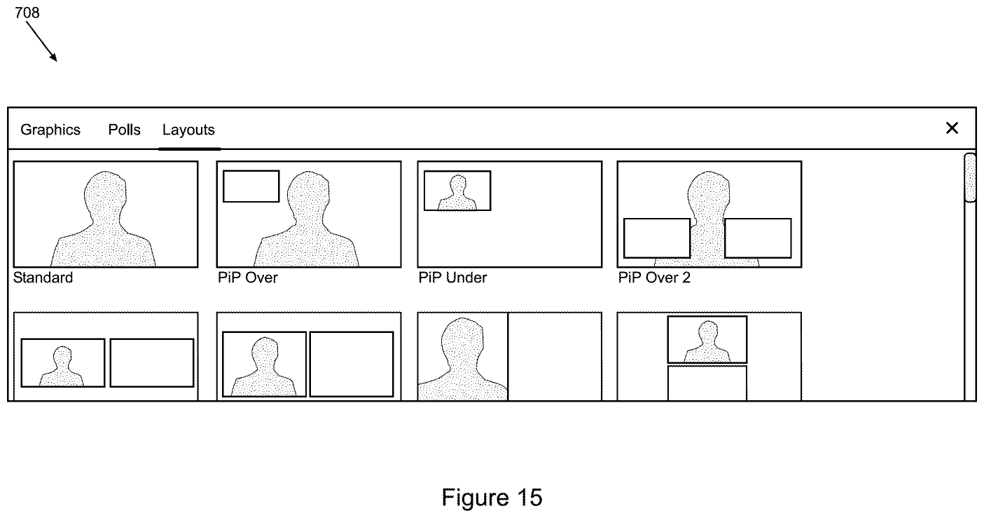

In a “Layouts” tab shown in FIG. 15, the control pane 708 displays templates that can be used to define various broadcast configurations. The layouts can, for instance, define a background and placements for various media content, such as graphics and/or live streams. Each layout is draggable onto the timeline 704 and/or the preview window 706. Once shown, the various portions of the layout can be defined through selection of the portion of the layout and the media content to be associated therewith.

For instance, the second layout defines a live stream to fill the broadcast window and a static graphic to fill the smaller window positioned in the upper left corner. Both the full window and smaller window are selectable by the user, and, upon selection, allow for media content to be selected from the sources panel 702.

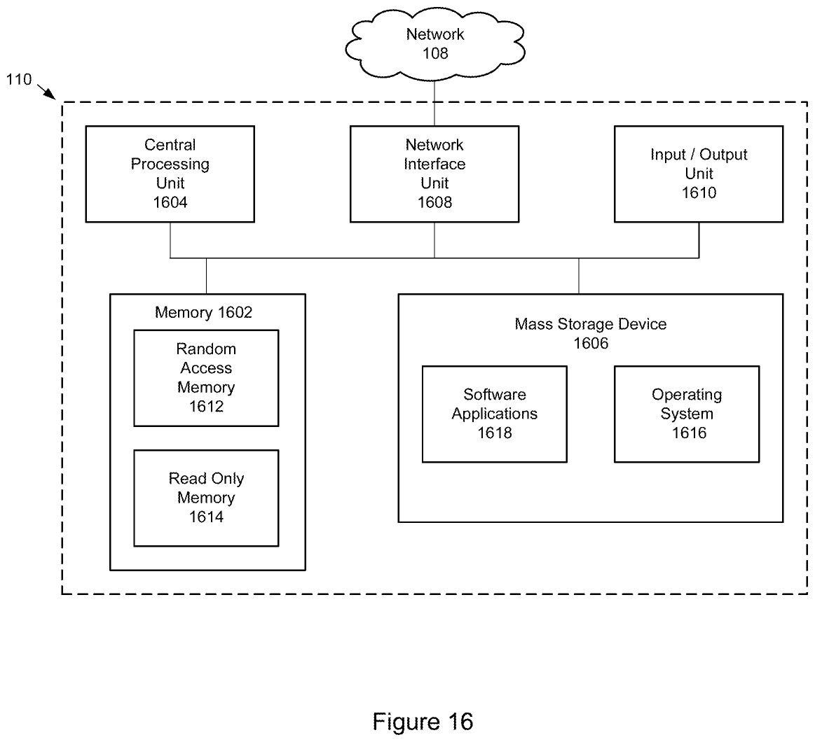

Referring now to FIG. 16, in the examples provided, the various components of the media content server 110 can be implemented on one or more computing devices. The computing devices can be configured in various ways, such as the traditional client/server configuration.

Each computing device can include various components, including a memory 1602, a central processing unit (or processor) 1604, a mass storage device 1606, a network interface unit or card 1608, an input/output unit 1610 (e.g., video interface, a display unit, and an external component interface). In other embodiments, computing devices are implemented using more or fewer hardware components. For instance, in another example embodiment, a computing device does not include a video interface, a display unit, an external storage device, or an input device.

The term computer readable media as used herein may include computer storage media, which can include random access memory 1612 and/or read only memory 1614. Computer storage media may include volatile and nonvolatile, removable and non-removable media implemented in any method or technology for storage of information, such as computer readable instructions, data structures, program modules, or other data. The memory includes one or more computer storage media capable of storing data and/or instructions.

As used in this document, a computer storage medium is a device or article of manufacture that stores data and/or software instructions readable by a computing device. In different embodiments, the memory is implemented in different ways. For instance, in various embodiments, the memory is implemented using various types of computer storage media. Example types of computer storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing system includes one or more physical integrated circuits that selectively execute software instructions. In various embodiments, the processing system is implemented in various ways. For example, the processing system can be implemented as one or more processing cores. In this example, the processing system can comprise one or more Intel microprocessors. In another example, the processing system can comprise one or more separate microprocessors.

The secondary storage device includes one or more computer storage media. The secondary storage device stores data and software instructions not directly accessible by the processing system. In other words, the processing system performs an I/O operation to retrieve data and/or software instructions from the secondary storage device. In various embodiments, the secondary storage device is implemented by various types of computer-readable data storage media. For instance, the secondary storage device may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card enables the computing device to send data to and receive data from a communication network. In different embodiments, the network interface card is implemented in different ways. For example, in various embodiments, the network interface card is implemented as an Ethernet interface, a token-ring network interface, a fiber optic network interface, a wireless network interface (e.g., WiFi, WiMax, etc.), or another type of network interface.

The video interface enables the computing device to output video information to the display unit. In different embodiments, the video interface is implemented in different ways. For instance, in one example embodiment, the video interface is integrated into a motherboard of the computing device. In another example embodiment, the video interface is a video expansion card. In various embodiments, the display unit can be a cathode-ray tube display, an LCD display panel, a plasma screen display panel, a touch-sensitive display panel, an LED screen, a projector, or another type of display unit. In various embodiments, the video interface communicates with the display unit in various ways. For example, the video interface can communicate with the display unit via a Universal Serial Bus (USB) connector, a VGA connector, a digital visual interface (DVI) connector, an S-Video connector, a High-Definition Multimedia Interface (HDMI) interface, a DisplayPort connector, or another type of connection.

The external component interface enables the computing device to communicate with external devices. In various embodiments, the external component interface is implemented in different ways. For example, the external component interface can be a USB interface, a FireWire interface, a serial port interface, a parallel port interface, a PS/2 interface, and/or another type of interface that enables the computing device to communicate with external devices. In different embodiments, the external component interface enables the computing device to communicate with different external components. For example, the external component interface can enable the computing device to communicate with external storage devices, input devices, speakers, phone charging jacks, modems, media player docks, other computing devices, scanners, digital cameras, a fingerprint reader, and other devices that can be connected to the computing device. Example types of external storage devices include, but are not limited to, magnetic tape drives, flash memory modules, magnetic disk drives, optical disc drives, flash memory units, zip disk drives, optical jukeboxes, and other types of devices comprising one or more computer storage media. Example types of input devices include, but are not limited to, keyboards, mice, trackballs, stylus input devices, key pads, microphones, joysticks, touch-sensitive display screens, and other types of devices that provide user input to the computing device.

The memory stores various types of data and/or software instructions. For instance, in one example, the memory stores a Basic Input/Output System (BIOS), and an operating system 1616. The BIOS includes a set of software instructions that, when executed by the processing system, cause the computing device to boot up. The operating system includes a set of software instructions that, when executed by the processing system, cause the computing device to provide an operating system that coordinates the activities and sharing of resources of the computing device, including one or more possible software applications 1618.

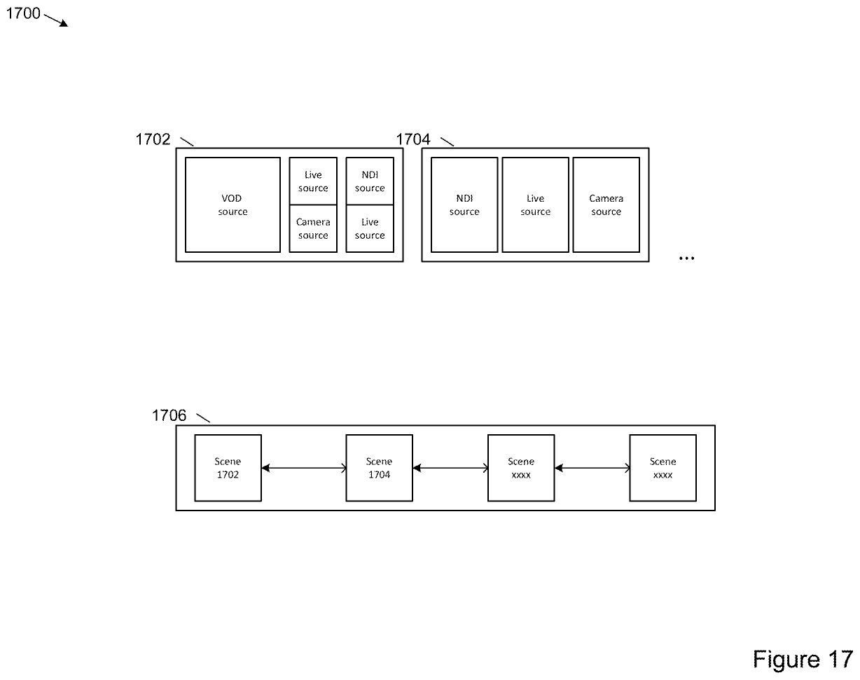

Referring now to FIG. 17, an example scenes module 1700 of the media content server 110 is shown. The scenes module 1700 treats each timeline item (see cards 1102, 1104, 1106 of the timeline 704 in FIG. 11) not as a single source, but an amalgam of different sources for each timeline item. For instance, each scene can be defined by multiple components, including different graphics, sources, etc.

An example scene 1702 allows for the definition of various attributes, such as a plurality of sources for the scene, such as video on-demand source, live source, etc. Similarly, another scene 1704 allows for the definition of different sources arranged in a different manner. The scenes 1702, 1704 are incorporated as cards of a time 1706, similar to that described above for timeline 704.

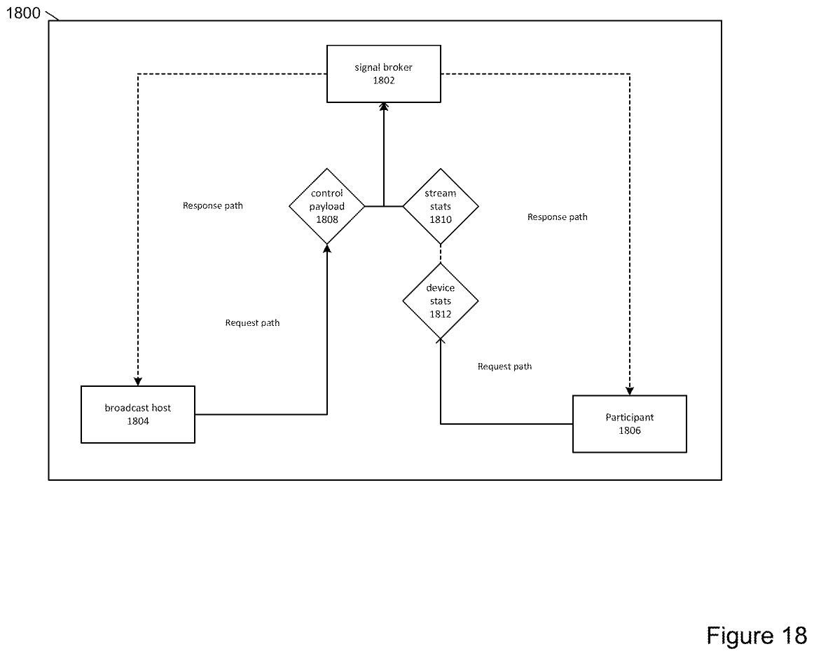

Referring now to FIG. 18, an example remote production module 1800 is shown for the media content server 110 of the system 100. The remote production module 1800 allows for the management of live content remotely, which can be a challenge, particularly with client devices and conditions being so varied. The remote production module 1800 provides the broadcast producer the ability to manage client video and audio settings as well as view detailed health and quality-of-stream metrics in real-time on behalf of the client.

More specifically, a broadcast signal broker 1802 manages the remote production, which allows a broadcast host 1804 to have enhanced remote production capabilities. This can include the ability for the broadcast host 1804 to remotely adjust camera and audio values for a participant 1806. Other configurations that can be controlled include video color temperature, resolution, focus in real-time, change a user's audio device or input levels, adjust PTZ (pan, tilt, zoom), start/stop a recorded copy of the stream, brightness, tint, resolution, etc.

A control payload control 1808 defines a data structure defining instructions specifying control points on a client device. For example, a request to upgrade a user's video capture resolution and pan left.

A stream stats control 1810 defines a data structure used for reporting health metrics and quality-of-stream in real-time. Such metrics can be specific for each participant 1806.

A device stats control 1812 defines a data structure used for reporting device state, capabilities, and functional control points for use. Again, these metrics can be specific for each participant 1806.

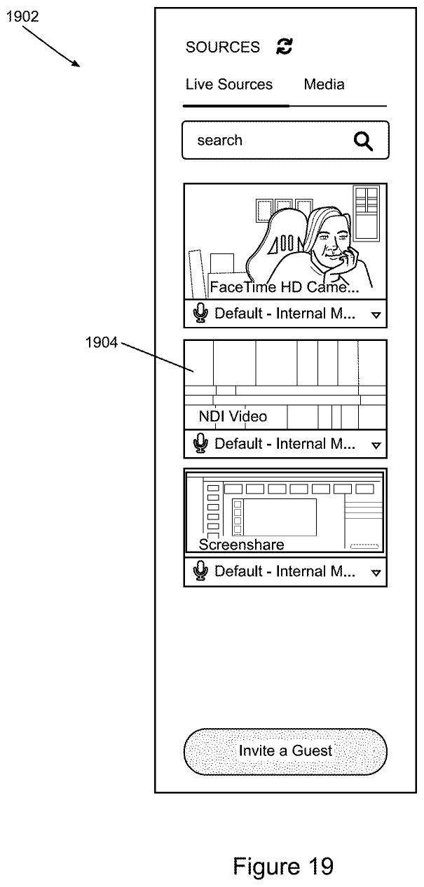

Referring now to FIG. 19, an example of another sources panel 1902 of the interface 700 is shown that allows for the media content server 110 to receive the selection of one or more sources of media content from the user. This sources panel 1902 is similar to the sources panel 702 described above.

However, the sources panel 1902 provides additional sources that can be selected. For instance, the sources panel 1902 includes an NDI source 1904 that allows for the use of a Network Device Interface (NDI) standard as another input source in the system 100. The NDI source 1904 enables video-compatible products to communicate, deliver, and receive high-definition video over a computer network in a high-quality, low-latency manner that is frame-accurate and suitable for switching in a live production environment. Many other types of sources and configurations are possible.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for distributing media content, comprising:
a processor;
memory encoding instructions which, when executed by the processor, cause the system to create a graphical user interface including:
a sources pane listing a plurality of sources of media content, the media content including both pre-recorded media content and live stream content;
a timeline listing a plurality of cards in a linear order, each of the plurality of cards representing specific media content;
a preview window displaying selected media content from the timeline;
a broadcast window displaying media content that is currently being broadcast; and
a channels pane displaying a plurality of channels to which the media content is broadcast.

2. The system of claim 1, wherein the sources pane allows for dragging of one of the plurality of sources of media content from the sources pane to the timeline.

3. The system of claim 1, wherein one of the plurality of sources of media content is defined by a Network Device Interface (NDI) standard.

4. The system of claim 1, wherein each of the plurality of cards in the timeline defines a scene allowing for a plurality of sources of content.

5. The system of claim 1, wherein the channels pane allows for selection of various social media platforms as the plurality of channels to which the media content is broadcast.

6. The system of claim 1, further comprising a remote production module programmed to manage video and audio settings for a plurality of clients consuming the media content.

7. The system of claim 6, wherein the remote production module is further programmed to provide health and quality-of-stream metrics in real-time on behalf of the plurality of clients consuming the media content.

8. The system of claim 1, wherein graphics are draggable onto the preview window so that the graphics are sizable and positionable on the media content.

9. The system of claim 1, further comprising a control module including a polls tab including selectable polls that solicit feedback from a client.

10. The system of claim 9, wherein the control module further includes a layouts tab with selectable templates that each defines various broadcast configurations.

11. A method for distributing media content, the method comprising:
providing a sources pane listing a plurality of sources of media content, the media content including both pre-recorded media content and live stream content;
providing a timeline listing a plurality of cards in a linear order, each of the plurality of cards representing specific media content;
providing a preview window displaying selected media content from the timeline;
providing a broadcast window displaying media content that is currently being broadcast; and
providing a channels pane displaying a plurality of channels to which the media content is broadcast.

12. The method of claim 11, wherein the sources pane allows for dragging of one of the plurality of sources of media content from the sources pane to the timeline.

13. The method of claim 11, wherein one of the plurality of sources of media content is defined by a Network Device Interface (NDI) standard.

14. The method of claim 11, wherein each of the plurality of cards in the timeline defines a scene allowing for a plurality of sources of content.

15. The method of claim 11, wherein the channels pane allows for selection of various social media platforms as the plurality of channels to which the media content is broadcast.

16. The method of claim 11, further comprising providing a remote production module programmed to manage video and audio settings for a plurality of clients consuming the media content.

17. The method of claim 16, wherein the remote production module is further programmed to provide health and quality-of-stream metrics in real-time on behalf of the plurality of clients consuming the media content.

18. The method of claim 11, wherein graphics are draggable onto the preview window so that the graphics are sizable and positionable on the media content.

19. The method of claim 11, further comprising providing a control module including a polls tab including selectable polls that solicit feedback from a client.

20. The method of claim 19, wherein the control module further includes a layouts tab with selectable templates that each defines various broadcast configurations.
